(19) United States
(12) Patent Application Publication
(10) Pub. No.: US 2024/0127374 A1
(43) Pub. Date: Apr. 18, 2024

(54) METHODS AND SYSTEMS FOR PROVIDING INTERACTIVE VIRTUAL TOUR OF REAL ESTATE PROPERTY

(71) Applicant: Direct Offer, Inc., Nashville, TN (US)

(72) Inventors: Kathleen Lappe, Nashville, TN (US); William Fox, Nashville, TN (US)

(73) Assignee: Direct Offer, Inc., Nashville, TN (US)

(21) Appl. No.: 17/968,780

(22) Filed: Oct. 18, 2022

(51) Int. Cl. G06Q 50/16; G06F 3/04815; G06F 16/438; G06F 16/483

(52) U.S. Cl. CPC G06Q 50/16; G06F 3/04815; G06F 16/4393; G06F 16/483

(57) ABSTRACT

The present invention relates to a system and a method for providing an interactive virtual tour of a real estate property. The method includes selecting a multimedia content (e.g., photo) from a plurality of multimedia contents by a user through a real estate module and playing an audio content associated with the selected multimedia content from the plurality of multimedia contents. The audio content elucidates a feature of the real estate property. Further, the method includes performing an action upon playing the audio content. The action can be, for example, but not limited to play back of the audio content, selection of a language from a plurality of languages to play the audio content, modification of an accent of the audio content, modification of a tone of the audio content, sharing of the audio content, and modification of an icon associated with the at least one selected multimedia content.

### CLAIM OF PRIORITY, IDENTIFICATION OF RELATED APPLICATIONS

This Non-Provisional patent application claims priority from U.S. Non-Provisional patent application Ser. No. 16/939,762 filed on 27 Jul. 2020 entitled “Electronic devices and methods for selecting and displaying multimodal content”, to common inventor Kathleen A. Lappe.

### TECHNICAL FIELD

The present invention generally relates to a real estate management platform, and more specifically to methods and systems for providing an interactive virtual tour of real estate properties.

### Problem Statement and History Interpretation Considerations

This section describes technical field in detail and discusses problems encountered in the technical field. Therefore, statements in the section are not to be construed as prior art.

### Discussion of History of the Problem

Common real estate platforms allow agents (aka “brokers”) and buyers to search, identify and even visit a property (e.g., land, building, flat, office space or the like). While these real estate platforms provide images and videos of the property, images and video can be misleading. After all, they do not provide minute details (aka “minor feature”) of the property, and the person recording the information—usually the seller or his agent—has every incentive to show positive property attributes and hide negative ones.

This sometimes results in disappointing buyer experiences. And, of course, if a potential buyer is interested in a property, they must visit the property verify details, which is time-consuming and can be expensive. In other words, audio and video as used by current platforms leads to distrust, rather than buyer confidence. There is presently no solution to these drawbacks. The present invention provides such a solution.

### SUMMARY

The above objective is achieved by systems and methods for providing an interactive virtual tour of a real estate property as defined in claims.

A real estate module is triggered by a user for the interactive virtual tour. After triggering the real estate module, the method determines whether a plurality of multimedia contents is in a draft stage or a presentation stage. The plurality of multimedia contents is associated with the real estate property from a plurality of real estate properties. In response to determining that the plurality of multimedia contents is in the draft stage, the method includes displaying the plurality of multimedia contents with at least one feature, selecting at least one multimedia content from the plurality of multimedia contents, modifying the at least one feature of the at least one selected multimedia content, previewing the at least one modified feature of the at least one selected multimedia content, confirming the at least one modified feature of the at least one selected multimedia content, and displaying the at least one modified feature of the at least one selected multimedia content. The at least one feature can be, for example, but not limited to an address, a location, longitude, latitude, a specific information, a landmark, type, size, and cost associated with the real estate property.

Alternatively, in response to determining that the plurality of multimedia contents is in the presentation stage, the method includes displaying the plurality of multimedia contents with the at least one feature, selecting the at least one multimedia content from the plurality of multimedia contents, modifying the at least one feature of the at least one selected multimedia content, viewing the at least one modified feature of the at least one selected multimedia content, and sharing the at least one modified feature of the at least one selected multimedia content. The at least one feature of the at least one selected multimedia content is modified by recording an audio content for the at least one selected multimedia content, and indicating the audio content upon confirming the recording of the audio content for the at least one selected multimedia content. The indication is provided in a form of indicia.

The user can select the multimedia content from the plurality of multimedia contents through the real estate module and play an audio content associated with the selected multimedia content from the plurality of multimedia contents. The audio content elucidates a feature of the real estate property. The real estate module enables the user to perform an action upon playing the audio content. The action can be, for example, but not limited to play back of the audio content, selection of a language from a plurality of languages to play the audio content, modification of an accent of the audio content, modification of a tone of the audio content, sharing of the audio content, and modification of an icon associated with the at least one selected multimedia content.

Of course, the present is simply a Summary, and not a complete description of the invention.

### BRIEF DESCRIPTION OF THE DRAWINGS

Various aspects of the invention and its embodiment are better understood by referring to the following detailed description. To understand the invention, the detailed description should be read in conjunction with the drawings.

FIG. 1 illustrates a system for providing an interactive virtual tour of a real estate property.

FIG. 2 is a flow chart illustrating various acts (aka “interactive virtual tour algorithm”) to provide the interactive virtual tour of the real estate property.

FIG. 3 is a flow chart illustrating a trigger act in conjunction with FIG. 2.

FIG. 4 is a flow chart illustrating an authentication act in conjunction with FIG. 2.

FIG. 5 is a flow chart illustrating a display property card act in conjunction with FIG. 2.

FIG. 6 is a flow chart illustrating a virtual tour creation algorithm using a draft act and a presentation act in conjunction with FIG. 2.

FIG. 7 is a flow chart illustrating an edit act in conjunction with FIG. 2.

FIG. 8 is a flow chart illustrating a record act in conjunction with FIG. 2.

FIG. 9 is a flow chart illustrating an audio tour showcase act in conjunction with FIG. 2.

FIG. 10 is a flow chart illustrating a method for providing the interactive virtual tour of the real estate property.

### DESCRIPTION OF AN EXEMPLARY PREFERRED EMBODIMENT

### Interpretation Considerations

While reading this section (Description of An Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described.

A function or an act should be interpreted as incorporating all modes of performing the function or act, unless otherwise explicitly stated. For instance, sheet drying may be performed through dry or wet heat application, or by using microwaves. Therefore, the use of the word “paper drying” invokes “dry heating” or “wet heating” and all other modes of this word and similar words such as “pressure heating”.

Unless explicitly stated otherwise, conjunctive words (such as “or”, “and”, “including”, or “comprising”) should be interpreted in the inclusive and not the exclusive sense.

As will be understood by those of the ordinary skill in the art, various structures and devices are depicted in the block diagram to not obscure the invention. In the following discussion, acts with similar names are performed in similar manners, unless otherwise stated.

The foregoing discussions and definitions are provided for clarification purposes and are not limiting. Words and phrases are to be accorded their ordinary, plain meaning, unless indicated otherwise.

### Description of the Drawings, a Preferred Embodiment

The present invention provides systems and methods using a set of algorithms which provides an interactive virtual tour of a real estate property to enhance the user experience and improve a mutually profitable success. The present invention is a data enrichment platform which combines a plurality of real estate properties to provide a knowledge to user(s) about the real estate property in an enhanced, cost and time effective manner.

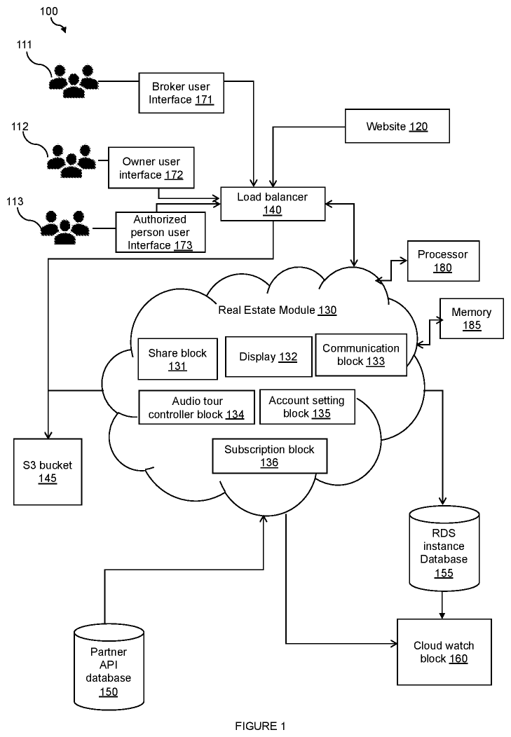

FIG. 1 illustrates a system 100 for providing the interactive virtual tour of the real estate property. The system 100 is, but not limited to, a cloud-based system. The system 100 may comprise subsystems, hardware, distributed computing, software, entity interfaces, and user interfaces which enable and deliver the services/functions of the present invention as described herein. The system 100 includes a website 120, a real estate module 130, a load balancer 140, an S3 bucket 145, a partner application programming interface (API) database 150, a Relational Database Service (RDS) instance database 155, a cloud watch block 160, a broker user interface 171, an owner user interface 172, an authorized person user interface 173, a processor 180 and a memory 185. Although, the real estate module 130 is shown in a cloud, but it is appreciated by those of skill in the art upon reading this application that the real estate module 130 may operate in cloud computing, a local server, a remote server, or on a user device, for example. Additionally, the local server may be selected to be (and includes within its meaning) an edge server, for example.

The real estate module 130 is accessed by one or more broker(s) (aka “agent, marketer or the like”) 111 through the broker user interface 171, one or more owner(s) 112 through the owner user interface 172, and one or more authorized person(s) 113 through the authorized person user interface 173 and one or more guest user(s) through the web site 120. The one or more broker(s) 111 through the broker user interface 171 and the one or more owner(s) 112 through the owner user interface 172 operate, upgrade, maintain and manage the real estate module 130. The at least one authorized person 113 through the authorized person user interface 173 and one or more guest user(s) through the website 120 interacts with the real estate module 130 to identify a suitable real estate property among the plurality of real estate properties.

The real estate module 130 itself is communicatively coupled to the user device (not shown). The user device can be a laptop, a notebook, a desktop computer, a vehicle to everything (V2X) device, a smartphone, a tablet, an internet of things (IoT) device, a television with communication facility, an immersive device, a virtual reality device, or any other computing device including similar hardened and field-specific devices, for example.

Further, the real estate module 130 acts as a core element of the system 100 and includes a share block 131, a display 132, a communication block 133, an audio tour controller block 134, an account setting block 135 and a subscription block 136. The display 132 can be, for example, but not limited to a light-emitting diode (LED) display, a Liquid Crystal Display (LCD) display, an edge display or the like.

The account setting block 135 allows for login or registration of the one or more broker(s) 111, the one or more owner(s) and a common user. The account setting block 135 saves a name of the user, a phone number of the user (e.g., one or more broker(s) 111, the one or more owner(s), common user or the like), an email ID of the user, a company name of the user or the like. The process of the login or the registration follows various existing techniques (e.g., one time password (OTP) based login/registration, facial recognition-based login/registration, fingerprint recognition-based login/registration or the like). Upon registering, the account setting block 135 authenticates the user. The process of the authentication follows various existing techniques (e.g., OTP based authentication, facial recognition-based authentication, fingerprint recognition-based authentication or the like). Upon the successful authentication, a homepage of the real estate module 130 is displayed on the display 132. If the authentication fails, then the account setting block 135 asks the user to reiterate the register/login process, whichever may deem fit.

Upon the successful authentication, the audio tour controller block 134 triggers an application programming interface (API) for the audio tour. After triggering the API, the audio tour controller block 134 determines whether the API call is valid or not. In response to determining that the API call is valid, the audio tour controller block 134 triggers the real estate module 130. Whereas if the API call is not valid, the real estate module 130 is not triggered. Once triggered, the real estate module 130 displays a hosted audio tour output/server partner website output (explained below in FIG. 9) on the website 120. While displaying the hosted audio tour output/server partner website output, the audio tour controller block 134 fetches one or more photo(s) (i.e., multimedia content(s)) of the real estate property for the audio tour. The audio tour controller block 134 displays the one or more fetched photo(s) and allows the user to select the one or more fetched photo(s) (“at least one multimedia content”) to play and listen to the audio related to the real estate property. In an example, the authorized user 113 may provide a search query as “Show me real estates in Washington”. In response to the search query, the audio tour controller block 134 fetches the one or more real estates photo(s) in Washington. The audio tour controller block 134 displays the one or more fetched real estates photo(s). The user may select the photo from the one or more fetched photo(s) to listen to the audio. Accordingly, the audio tour controller block 134 playbacks the audio for the selected photo(s). The audio may elucidate one or more feature(s) of the real estate property. The one or more feature(s) can be selected from a list comprising, for example, but not limited to an address, a location, longitude, latitude, a specific information, a landmark, type, size, and cost associated with the real estate property.

Further, the audio tour controller block 134 performs one or more action(s) upon playing the audio (or audio content). The one or more action(s) can be, for example, but not limited to play back of the audio content, selection of at least one language from a plurality of languages (e.g., English language, German language, Arabic language, Chinese language, Hindi language or the like) to play the audio content, modification of an accent of the audio content, modification of a tone of the audio content, sharing of the audio content through the share block 131 (through e.g., Short Message Service (SMS), social media, chat or the like), and modification of an icon associated with the at least one selected multimedia content (e.g., image/photo, video or the like). For example, the user closes the icon associated with an image of the real estate property and the user expands the icon associated with the image of the real estate property.

Alternatively, upon the successful authentication, the audio tour controller block 134 displays the audio tour page/screen, the property card and an image and address on the property card on the display 132. The audio tour controller block 134 determines whether a click on the image is received from the user. If no click is determined or recognized, then the audio tour controller block 134 continues to display the property card to the user. If the click is determined or recognized, then the audio tour controller block 134 enables the user to click a lock icon on the property card and navigates to a subscriber model through the subscription block 136, where the subscription block 136 saves subscription details of the user. Also, the audio tour controller block 134 navigates to the audio tour screen and the image/photo gallery, on the display 132 respectively.

The audio tour controller block 134 allows the user to draft/create the property card and/or make changes to the published property card. During drafting/creation of the property card, the audio tour controller block 134 displays the image and the address of the real estate property. The audio tour controller block 134 allows the user to edit/modify the image and/or address on the display 132, where the user can further select preview showcase of the edited image and/or edited address. After the preview, the audio tour controller block 134 proceeds to publish the edited image and/or the edited address. The audio tour controller block 134 enables the user to confirm whether to publish the edited image and/or the edited address. Upon the confirmation to publish, the audio tour controller block 134 displays the image and the address, respectively.

In addition to creation/drafting of the property card, the audio tour controller block 134 allows the user to edit the published image and/or address on the display 132. Further, the audio tour controller block 134 provides an option to view showcase of the published edited image and/or edited address. After the showcase, the audio tour controller block 134 allows the user to share the edited image and/or the edited address through the share block 131.

The audio tour controller block 134 enables the user to record audio for a selected photo(s) of the real estate property. During the recording process, the user selects the photo gallery, where the audio tour controller block 134 displays a grid of photos associated with the real estate property. Although, the photo gallery is explained in view of the grid, however, the photo gallery is not restricted by any specific view. The user can select the photo from the photo gallery and record the audio with the selected photo. The user can then save the selected photo with the audio, where the audio tour controller block 134 indicates the audio associated with the saved photo.

While appending/adding the audio to the selected photo, the audio tour controller block 134 navigates the selected photo to a recording studio panel. The audio tour controller block 134 displays and indicates the recorded audio with the selected photo using an indicia, for example, a play button, a pause button, a stop button, a length of the audio, the timeline of the audio, re-record audio information option and delete audio information option.

The communication block 133 enables and simplifies communication between all of participants/users of the system 100 by bringing an instant messaging layer as a central mode of communication among each other. Further, the communication block 133 enables communication among all the components of the system 100.

The processor 180 comprises one or more processing units, which may be configured to perform all the processing functionalities of the present invention. The one or more processing units may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU), for example. Further, functions associated with the real estate module 130 may be performed by utilizing the information stored in the memory 185 like a non-volatile memory, volatile memory, for example and by utilizing the processor 180. The memory 185 stores the information/data relevant to fulfil the methods described herein.

The load balancer 140 manages the load/traffic on the real estate module 130 and the S3 bucket 145 when the one or more broker(s) 111, the one or more owner(s) 112, the at least one authorized person 113, and the one or more guest user(s) access the real estate module 130 at a time. The S3 bucket 145 is a public cloud storage resource database for storing information corresponding to the real estate properties and the one or more broker(s) 111, the one or more owner(s) 112, the at least one authorized person 113, and the one or more guest user(s). The S3 bucket 145 also stores one or more audio files associated with the audio content and system logs.

The partner API database 150 is a source for listing data from the one or more owner(s) 112. The RDS instance database 155 is a collection of managed services that makes it simple to set up, operate, and scale databases in the cloud. The RDS instance database 155 is coupled with the cloud watch block 160 and the real estate module 130. The partner API database 150 and the RDS instance database 155, generally, may be realized through various technologies such as, but not limited to, Microsoft® SQL, Access®, Azure®, Oracle IBM DB2®, PostgreSQL®, MySQL® and SQLite®, and the like. The cloud watch block 160 stores various logs of the real estate properties and the one or more broker(s) 111, the one or more owner(s) 112, the at least one authorized person(s) 113, and the guest users. Also, the cloud watch block 160 monitors resource of the real estate property, a service condition of the real estate property and status of the real estate property.

Although FIG. 1 shows various components of the system 100 but it is to be understood that other embodiments are not limited thereon. The system 100 may include less or more number of components. Further, the labels or names of the components are used only for illustrative purpose and do not limit the scope of the present invention. One or more components can be combined together to perform same or substantially similar function in the system 100.

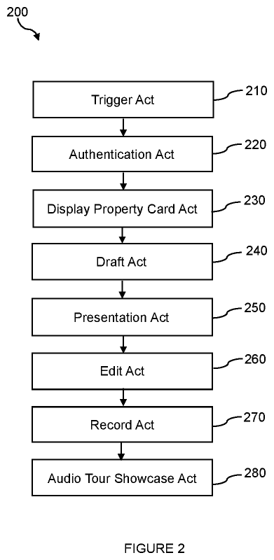

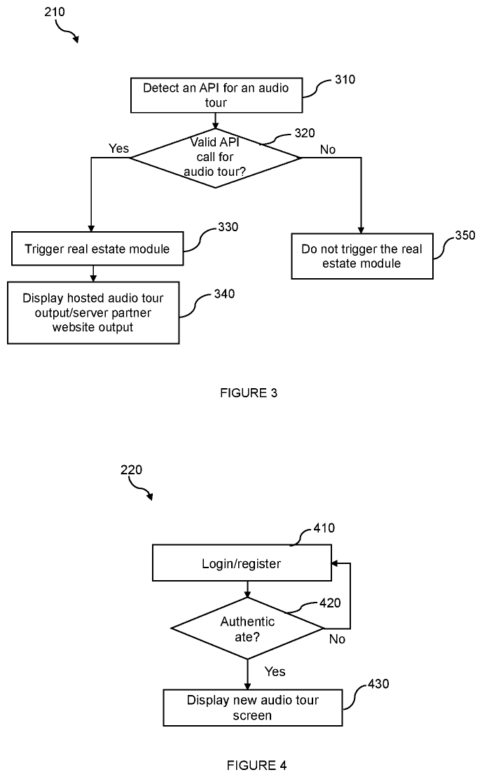

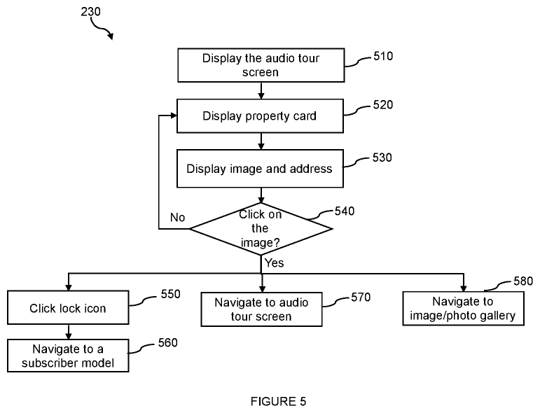

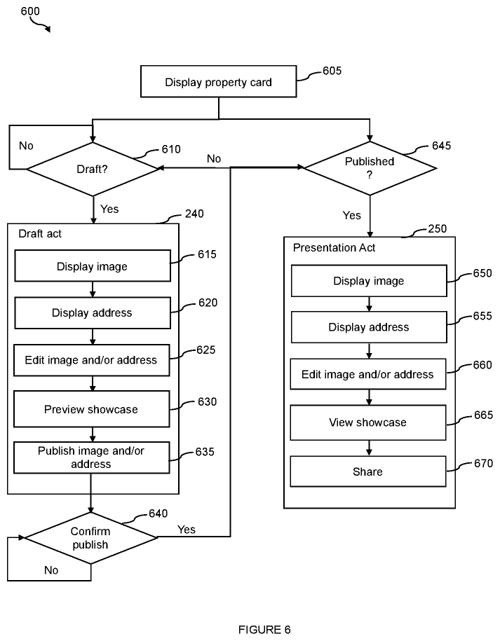

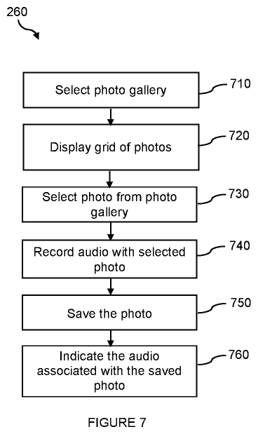

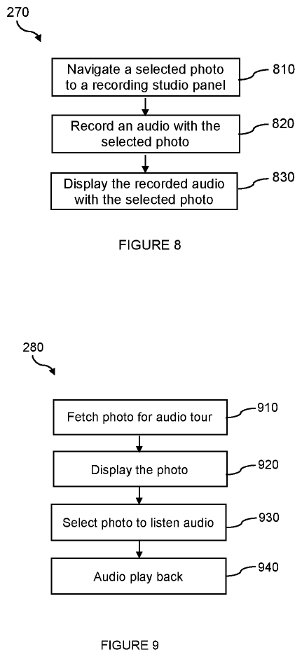

Now simultaneous reference is made to FIG. 2 through FIG. 9, in which FIG. 2 is a flow chart illustrating various acts (aka “interactive virtual tour algorithm”) 200 to provide the interactive virtual tour of the real estate property; FIG. 3 is a flow chart illustrating a trigger act 210 in conjunction with FIG. 2; FIG. 4 is a flow chart illustrating an authentication act 220 in conjunction with FIG. 2; FIG. 5 is a flow chart illustrating a display property card act 230 in conjunction with FIG. 2; FIG. 6 is a flow chart illustrating a virtual tour creation algorithm 600 using a draft act 240 and a presentation act 250 in conjunction with FIG. 2; FIG. 7 is a flow chart illustrating an edit act 260 in conjunction with FIG. 2; FIG. 8 is a flow chart illustrating a record act 270 in conjunction with FIG. 2; and FIG. 9 is a flow chart illustrating an audio tour showcase act 280 in conjunction with FIG. 2.

The operations begin at the trigger act 210. The trigger act 210 is explained in detail in FIG. 3. In the trigger act 210, at step 310, the audio tour controller block 134 detects the API for the audio tour. After detecting the API, at step 320, the audio tour controller block 134 determines whether the API call is valid or not. At step 330, in response to determining that the API call is valid, then the audio tour controller block 134 triggers the real estate module 130. At step 340, upon triggering the real estate module 130, the real estate module 130 displays the hosted audio tour output/server partner website output (explained below in FIG. 9). At step 350, in response to determining that the API call is not valid, the real estate module 130 does not get triggered.

Following the trigger act 210, the authentication act 220 begins, which is explained in conjunction with FIG. 4. Referring to FIG. 4, in the authentication act 220, at step 410, the account setting block 135 allows the user to login or register himself/herself. The process of the login or the registration follows various existing techniques. At step 420, upon registering, the account setting block 135 authenticates the user using at least one of a various existing technique. Upon the successful authentication, at step 430, the account setting block 135 displays the audio tour screen on the display 132. If the authentication fails, then the account setting block 135 iterates the process of registration.

In an embodiment, the trigger act 210 is performed first and then authentication act 220 is performed. In another embodiment, the authentication act 220 is performed first and then the trigger act 210 is performed.

Following the authentication act 220, the display property card act 230 begins which is explained in conjunction with FIG. 5. At step 510, step 520, and step 530, the audio tour controller block 134 displays the audio tour screen, the property card and the image and address on the property card, respectively, through the display 132. At step 540, the audio tour controller block 134 determines the click (or any sensory input) received from the user on the image. If no click is determined or recognized, then the operation moves back to step 520 to display the property card. If the click is determined or recognized, then at step 550 and step 560, the audio tour controller block 134 enables the user to click the lock icon on the property card and navigates to a subscriber model through the subscription block 136, respectively. At step 570 and step 580, the audio tour controller block 134 navigates to the audio tour screen and the image/photo gallery, respectively.

Following the display property card act 230, the virtual tour creation algorithm 600 incorporating the draft act 240 and the presentation act 250 begins as shown in FIG. 6. In an embodiment, at step 605, the audio tour controller block 134 displays the property card. The audio tour controller block 134 determines, at steps 610 and 645, whether to begin the draft act 240 or the presentation act 250.

In the draft act 240, at step 615 and step 620, the audio tour controller block 134 displays the image and the address of the real estate property, respectively. At step 625, the audio tour controller block 134 allows the user to edit the image and/or address on the display 132. At step 630, the user can preview showcase of the edited image and/or edited address. After the preview, at step 635, the audio tour controller block 134 proceeds to publish the edited image and/or the edited address. At step 640, the audio tour controller block 134 enables the user to confirm whether to publish the edited image and/or the edited address or not. Upon the confirmation to publish, the audio tour controller block 134 publishes the image and/or the address, respectively.

As shown in FIG. 6, following the draft act 240, the presentation act 250 begins, where the audio tour controller block 134 allows/enables the user to edit the published image and/or address. Particularly, at step 650 and step 655, the image and the address are displayed, respectively. At step 660, the audio tour controller block 134 allows the user to edit the published image and/or address on the display. At step 665, the audio tour controller block 134 provides an option to view showcase of the published edited image and/or edited address. After the showcase, at step 670, the audio tour controller block 134 allows the user to share the edited image and/or the edited address through the share block 131.

Following the draft act 240 and/or the presentation act 250, the edit act 260 begins, which is explained in conjunction with FIG. 7. At step 710, the audio tour controller block 134 enables the user to select the photo gallery related to the real estate property. Upon selection, at step 720, the audio tour controller block 134 displays a grid of photos associated with the real estate property. At step 730, the user selects the photo from the photo gallery. Upon selection, at step 740, the audio tour controller block 134 enables the user to record the audio with the selected photo. At step 750, the user saves the selected photo with the audio and at step 760, the audio tour controller block 134 indicates the audio associated with the saved photo.

Following the edit act 260, the record act 270 begins, which is explained in conjunction with FIG. 8. At step 810, the audio tour controller block 134 navigates the selected photo to a recording studio panel. At step 820, the audio tour controller block 134 allows the user to record the audio with the selected photo. At step 830, the audio tour controller block 134 displays the recorded audio with the selected photo. The selected photo indicates a play button, a pause button, a stop button, a length of the audio, the timeline of the audio and delete audio information option.

Following the record act 270, the audio tour showcase act 280 begins, which is explained in conjunction with FIG. 9. At step 910, the audio tour controller block 134 fetches the photo for the audio tour. At step 920, the audio tour controller block 134 displays the fetched photo. At step 930, the audio tour controller block 134 enables the user to select the fetched photo to listen to the audio. At step 940, the audio tour controller block 134 playbacks/plays the audio.

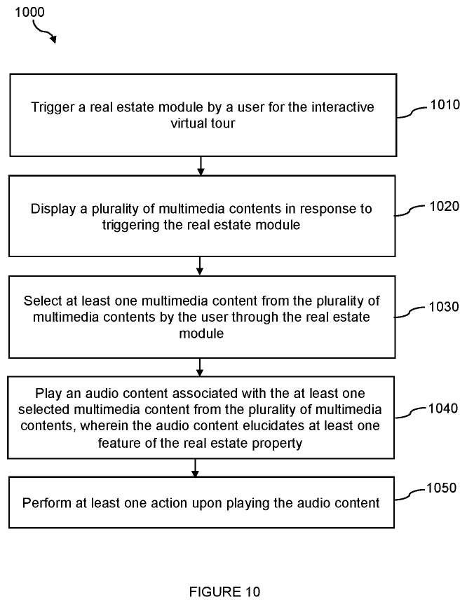

FIG. 10 is a flow chart 1000 illustrating a method for providing the interactive virtual tour of the real estate property (“interactive virtual tour method 1000”). At step 1010, the real estate module 130 is triggered by the user of the interactive virtual tour system 100. At step 1020, the real estate module 130 displays the plurality of multimedia contents in response to triggering the real estate module 130. The plurality of multimedia contents is associated with the real estate property from the plurality of real estate properties. At step 1030, the user selects the multimedia content from the plurality of multimedia contents through the real estate module 130. At step 1040, the real estate module 130 plays the audio content associated with the selected multimedia content from the plurality of multimedia contents. The audio content elucidates the at least one feature of the real estate property. At step 1050, the real estate module 130 performs an action upon playing the audio content. The action can be, for example, but not limited to play back of the audio content, selection of at least one language from a plurality of languages to play the audio content, modification of an accent of the audio content, modification of a tone of the audio content, sharing of the audio content, and modification of an icon associated with the selected multimedia content.

It may be noted that FIGS. 2 through 10 are to be understood in conjunction with FIG. 1.

Although, the real estate module 130 is explained in view of the one or more broker(s) 111, the one or more owner(s) 112 and the one or more authorized person(s) 113, however, the real estate module 130 is not limited to the one or more broker(s) 111, the one or more owner(s) 112 and the one or more authorized person(s) 113 only and is also applicable to the other users as explained in conjunction with FIG. 1.

The various actions, acts, blocks, steps, or the like in the flow diagrams/charts 200, 210, 220, 230, 240, 250, 260, 270, 280, 600 and 1000 may be performed in the order presented, in a different order or simultaneously. Further, in some embodiments, some of the actions, acts, blocks, steps, or the like may be omitted, added, modified, skipped, or the like without departing from the scope of the present invention.

Unless otherwise defined, all technical and scientific terms used herein have the same meaning as commonly understood by one of ordinary skill in the art to which this invention belongs. Although methods and materials similar to or equivalent to those described herein can be used in the practice or testing of equivalent systems and methods, suitable systems and methods and are described above.

Although the invention has been described and illustrated with specific illustrative embodiments, it is not intended that the invention be limited to those illustrative embodiments. Those skilled in the art will recognize that variations and modifications can be made without departing from the spirit of the invention. Therefore, it is intended to include within the invention, all such variations and departures that fall within the scope of the appended claims and equivalents thereof.

TABLE
List of Reference Numerals/Glossary

| Reference | |
|---|---|
| Numeral | Element Name |
| 100 | System |
| 111 | One or more broker(s) |
| 112 | One or more owner(s) |
| 113 | One or more authorized person(s) |
| 120 | Website |
| 130 | Real estate module |
| 131 | Share block |
| 132 | Display |
| 133 | Communication block |
| 134 | Audio tour controller block |
| 135 | Account setting block |
| 136 | Subscription block |
| 140 | Load balancer |
| 145 | S3 bucket |
| 150 | Partner API Database |
| 155 | RDS instance Database |
| 160 | Cloud watch block |
| 171 | Broker user interface |
| 172 | Owner user interface |
| 173 | Authorized person user interface |
| 180 | Processor |
| 185 | Memory |
| 200 | Interactive virtual tour algorithm |
| 210 | Trigger act |
| 220 | Authentication act |
| 230 | Display property card act |
| 240 | Draft act |
| 250 | Presentation act |
| 260 | Edit act |
| 270 | Record act |
| 280 | Audio tour showcase act |
| 600 | Virtual tour creation algorithm |
| 1000 | Interactive virtual tour method |

What is claimed is:

1. A method for providing an interactive virtual tour of a real estate property, the method comprising:
triggering a real estate module by a user for the interactive virtual tour;
displaying, by the real estate module, a plurality of multimedia contents in response to triggering the real estate module, wherein the plurality of multimedia contents is associated with the real estate property from a plurality of real estate properties;
selecting at least one multimedia content from the plurality of multimedia contents by the user through the real estate module;
playing an audio content associated with the at least one selected multimedia content from the plurality of multimedia contents, wherein the audio content elucidates at least one feature of the real estate property; and
performing, by the real estate module, one or more actions upon playing the audio content, wherein the one or more actions comprise play back of the audio content, selection of at least one language from a plurality of languages to play the audio content, modification of an accent of the audio content, modification of a tone of the audio content, sharing of the audio content, and modification of an icon associated with the at least one selected multimedia content.

2. The method of claim 1 wherein displaying, by the real estate module, the plurality of multimedia contents further comprises:
determining, by the real estate module, whether the plurality of multimedia contents is in a draft stage and a presentation stage; and
performing, by the real estate module, at least one of:
in response to determining that the plurality of multimedia contents is in the draft stage:
displaying the plurality of multimedia contents with at least one feature,
selecting at least one multimedia content from the plurality of multimedia contents,
modifying the at least one feature of the at least one selected multimedia content,
previewing the at least one modified feature of the at least one selected multimedia content,
confirming the at least one modified feature of the at least one selected multimedia content, and
displaying the at least one modified feature of the at least one selected multimedia content; and
in response to determining that the plurality of multimedia contents is in the presentation stage:
displaying the plurality of multimedia contents with the at least one feature,
selecting the at least one multimedia content from the plurality of multimedia contents,
modifying the at least one feature of the at least one selected multimedia content,
viewing at least one modified feature of the at least one selected multimedia content, and
sharing the at least one modified feature of the at least one selected multimedia content.

3. The method of claim 2 wherein modifying the at least one feature of the at least one selected multimedia content comprises:
recording an audio content for the at least one selected multimedia content; and
indicating the audio content upon confirming the recording of the audio content for the at least one selected multimedia content, wherein the indication is provided in a form of indicia.

4. The method of claim 1 wherein the at least one feature is selected from a list comprising at least one of an address, a location, longitude, latitude, a specific information, a landmark, type, size, and cost associated with the real estate property.

5. A system for providing an interactive virtual tour of a real estate property, the system comprising:
a processor;
a memory; and
a real estate module, coupled with the processor and the memory, configured to:
display a plurality of multimedia contents in response to triggering the real estate module, wherein the plurality of multimedia contents is associated with the real estate property from a plurality of real estate properties;
select at least one multimedia content from the plurality of multimedia contents by a user;
play an audio content associated with the at least one selected multimedia content from the plurality of multimedia contents, wherein the audio content elucidates at least one feature of the real estate property; and
perform one or more actions upon playing the audio content, wherein the one or more actions comprise play back of the audio content, selection of at least one language from a plurality of languages to play the audio content, modification of an accent of the audio content, modification of a tone of the audio content, sharing of the audio content, and modification of an icon associated with the at least one selected multimedia content.

6. The system of claim 5 wherein display the plurality of multimedia contents comprises:
determine whether the plurality of multimedia contents is in a draft stage and a presentation stage; and
perform at least one of:
in response to determining that the plurality of multimedia contents is in the draft stage:
display the plurality of multimedia contents with at least one feature,
select at least one multimedia content from the plurality of multimedia contents,
modify the at least one feature of the at least one selected multimedia content,
preview the at least one modified feature of the at least one selected multimedia content,
confirm the at least one modified feature of the at least one selected multimedia content, and
display the at least one modified feature of the at least one selected multimedia content on; and
in response to determining that the plurality of multimedia contents is in the presentation stage:
display the plurality of multimedia contents with the at least one feature,
select the at least one multimedia content from the plurality of multimedia contents,
modify the at least one feature of the at least one selected multimedia content,
view at least one modified feature of the at least one selected multimedia content, and
share the at least one modified feature of the at least one selected multimedia content.

7. The system of claim 6 wherein modify the at least one feature of the at least one selected multimedia content comprises:
record an audio content for the at least one selected multimedia content; and
indicate the audio content upon confirming the recording of the audio content for the at least one selected multimedia content, wherein the indication is provided in a form of indicia.

8. The system of claim 5 wherein the at least one feature is selected from a list comprising at least one of an address, a location, longitude, latitude, a specific information, a landmark, type, size, and cost associated with the real estate property.
